(19) United States
(12) Patent Application Publication
(10) Pub. No.: US 2024/0005408 A1
(43) Pub. Date: Jan. 4, 2024

(54) METHOD FOR GENERATING A TREE DIAGRAM OF A SHAREHOLDING STRUCTURE

(71) Applicant: BluePlanet Inc., Taipei City (TW)

(72) Inventors: Bo-Ru LIN, Taipei City (TW); Shang-De YOU, Taipei City (TW); Hsien-Chun MENG, Taipei City (TW); Ching-Yi WANG, Taipei City (TW); San-Wen CHEN, Taipei City (TW)

(21) Appl. No.: 18/341,266

(22) Filed: Jun. 26, 2023

(30) Foreign Application Priority Data
Jun. 29, 2022 (TW) 111124317

(51) Int. Cl. G06Q 40/06; G06T 11/20; G06F 3/04817

(52) U.S. Cl. CPC G06Q 40/06; G06T 11/206; G06F 3/04817; G06T 2200/24

(57) ABSTRACT

A method for generating a tree diagram of a shareholding structure from a capitalization table of a company, includes: generating a plurality of interactive icons that include a root node icon associated with the company, and a plurality of stem node icons each associated with a respective one of a plurality of related-parties recorded in the capitalization table, each of the related-parties being a partial owner or a subsidiary party; arranging the root node icon at an origin of the tree diagram, and arranging the stem node icons in the tree diagram such that the stem node icons associated with partial owners are on one side of the tree diagram and the stem node icons associated with the subsidiary parties are on an opposite side of the tree diagram; and plotting a plurality of investment routes each connecting two interactive icons arranged in the tree diagram.

### CROSS-REFERENCE TO RELATED APPLICATION

This application claims priority to Taiwanese Invention Patent Application No. 111124317, filed on Jun. 29, 2022.

### FIELD

The disclosure relates to a method for generating a tree diagram, and more particularly to a method for generating a tree diagram of a shareholding structure.

### BACKGROUND

In the field of finance, a capitalization table is a ledger that contains information of ownership of a company. The capitalization table has been a crucial element in banking. It is noted that as the company grows bigger, the ownership may become increasingly complex, and more beneficial owners of the company may be involved. In commercial law, the term “beneficial owner” typically is defined as and refers to a natural person who ultimately owns or controls the company. In practice, the beneficial owner may own directly or indirectly more than a certain percentage of controlling shares of the company (e.g., 25%). Since each of the beneficial owners may own interests in other entities that also own the company, presenting the relationships among the beneficial owner(s) and the entities may be a challenge.

### SUMMARY

As strong demand for identifying beneficial ownership in a company persists, it is beneficial to introduce a new way of presenting information contained in a capitalization table in a manner that is more intuitive for users. Therefore, an object of the disclosure is to provide a method that generates a tree diagram of a shareholding structure from the capitalization table to present information included in the capitalization table more intuitively to the users.

According to the one embodiment of the disclosure, the method is for generating a tree diagram of a shareholding structure from a capitalization table of a company. Content of the capitalization table includes a name of the company, and a plurality of related-party datasets that respectively correspond to a plurality of related-parties. Each of the related-party datasets including a name of the respective related-party, a type of entity of the respective related-party, and a percentage of ownership related to the respective related-party. Each of the related-parties being one of a partial owner of the company who owns a percentage of the property of the company and a subsidiary party a percentage of whose property is owned by the company. The method is implemented using a processor of an electronic device and includes:
in response to receipt of user input instructions, loading the capitalization table of the company;
generating a plurality of interactive icons that are associated with the company and the related-parties for the tree diagram, wherein the interactive icons include a root node icon that is associated with the company, and a plurality of stem node icons that are each associated with a respective one of the related-party datasets;
arranging the plurality of interactive icons including the root node icon and the plurality of stem node icons in the tree diagram, the tree diagram being in the form of a two-dimensional plot, wherein arranging the plurality of interactive icons includes:
   arranging the root node icon at an origin of the tree diagram,
   arranging those of the stem node icons that are associated with partial owners on one side of the tree diagram, and
   arranging those of the stem node icons that are associated with subsidiary parties on an opposite side of the tree diagram; and
plotting a plurality of investment routes each connecting two interactive icons arranged in the tree diagram.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an electronic device according to one embodiment of the disclosure.

FIG. 2 is a flow chart illustrating steps of a method for generating a tree diagram of a shareholding structure from a capitalization table according to one embodiment of the disclosure.

FIG. 3 illustrates an intermediate stage of generating an exemplary tree diagram according to one embodiment of the disclosure.

FIGS. 4 and 5 are exemplary tree diagrams different from that of FIG. 3 with duplicate interactive icon (s) to be removed.

FIG. 6 illustrates an exemplary tree diagram that is different from those of FIGS. 3 to 5 and that is generated using the method as shown in FIG. 2.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

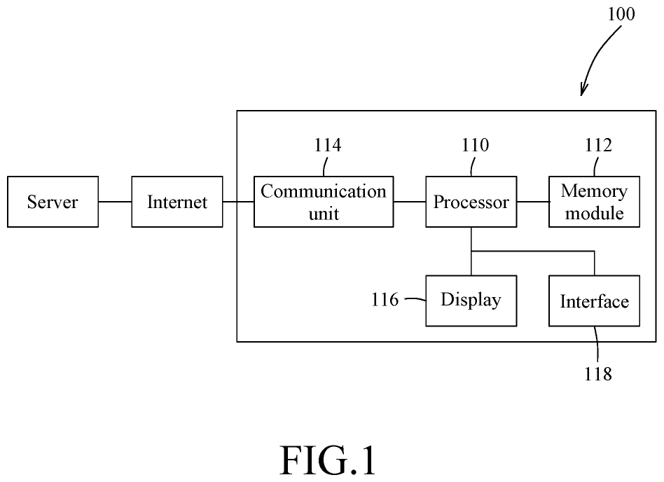

FIG. 1 is a block diagram illustrating an electronic device 100 according to one embodiment of the disclosure. In this embodiment, the electronic device 100 is embodied using a computer, and includes a processor 110, a memory module 112, a communication unit 114, a display 116, and an interface 118.

The processor 110 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The memory module 112 is connected to the processor 110, and may be embodied using, for example, random access memory (RAM), read only memory (ROM), programmable ROM (PROM), firmware, and/or flash memory, etc. The memory module 112 stores a software application including instructions that, when executed by the processor 110, cause the processor 110 to perform operations as described below.

The communication unit 114 is connected to the processor 110, and may include one or more of a radio-frequency integrated circuit (RFIC), a short-range wireless communication module supporting a short-range wireless communication network using a wireless technology of Bluetooth® and/or Wi-Fi, etc., and a mobile communication module supporting telecommunication using Long-Term Evolution (LTE), the third generation (3G), the fourth generation (4G) or fifth generation (5G) of wireless mobile telecommunications technology, or the like.

The display 116 is connected to the processor 110, and may be embodied using a liquid crystal display (LCD), a light-emitting diode (LED) display or other forms of displays.

The interface 118 is connected to the processor 110, and may be embodied using a keyboard and/or a mouse, etc. In some embodiments, the display 116 and the interface 118 may be integrated using a touch screen.

In use, the electronic device 100 may be associated with a user (a natural person, a representative of a legal entity such as a bank or a law firm, etc.), and the user may wish to view ownership of a company. As such, the user may operate the interface 118 to control the electronic device 100 to implement a method for generating a tree diagram from a capitalization table. Specifically, the user may operate the interface 118 to control the electronic device 100 to execute the software application stored in the memory module 112.

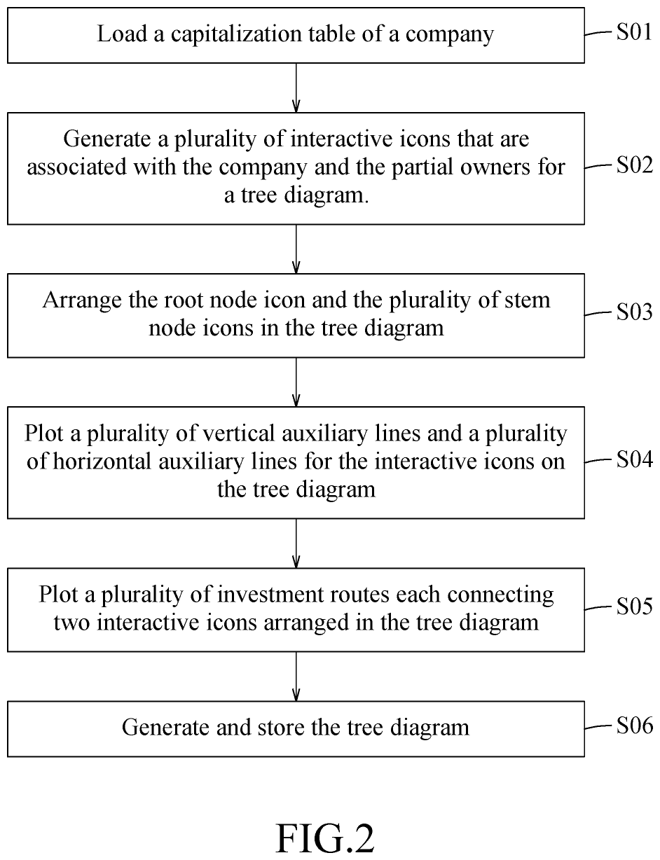

FIG. 2 is a flow chart illustrating steps of a method for generating the tree diagram of a shareholding structure from the capitalization table according to one embodiment of the disclosure. In this embodiment, the method is implemented using the electronic device 100 shown in FIG. 1.

In step S01, in response to receipt of user input instructions from the interface 118, the processor 110 executing the software application loads the capitalization table of the company.

Specifically, the capitalization table may be pre-stored in the memory module 112, or may be obtained from a server (not shown) through a network (e.g., the Internet) by the communication unit 114. The capitalization table includes information related to the ownership associated with the company. For example, in this embodiment, content of the capitalization table includes a name of the company, and a plurality of related-party datasets that are respectively associated with a plurality of related-parties. Each of the related-party datasets includes a name of a related-party, a type of entity of the respective related-party, a property owned by the respective related-party, and a percentage of ownership of the property related to the respective related-party.

Specifically, a related-party of the company may be one of the following: a partial owner of the company who owns a percentage of the property of the company directly or indirectly, a subsidiary party a percentage of whose property is owned by the company directly or indirectly, and an affinity party which may not directly own any percentage of the property of the company, but: 1) owns a percentage of the property of a subsidiary party of the company; and 2) has a percentage of the property that is owned by a partial owner of the company.

Specifically, the type of entity of the partial owner may be a natural person, a domestic juridical person (e.g., a company, a firm, a foundation, an educational institution, etc.), a governmental institution, a foreign juridical person, etc. The property owned by the partial owner may be shares of the company. The type of entity of the subsidiary party and the type of entity of the affinity party may be a domestic juridical person, a governmental institution, a foreign juridical person, etc. In step S02, the processor 110 generates a plurality of interactive icons that are associated with the company and the related-party for the tree diagram. Specifically, the processor 110 generates a root node icon that is associated with the company, and a plurality of stem node icons that are associated with the related-parties, respectively. Content of the stem node icons is obtained from the related-party datasets. Each of the stem node icons is associated with one of the related-parties, which may be a partial owner, a subsidiary party or an affinity party.

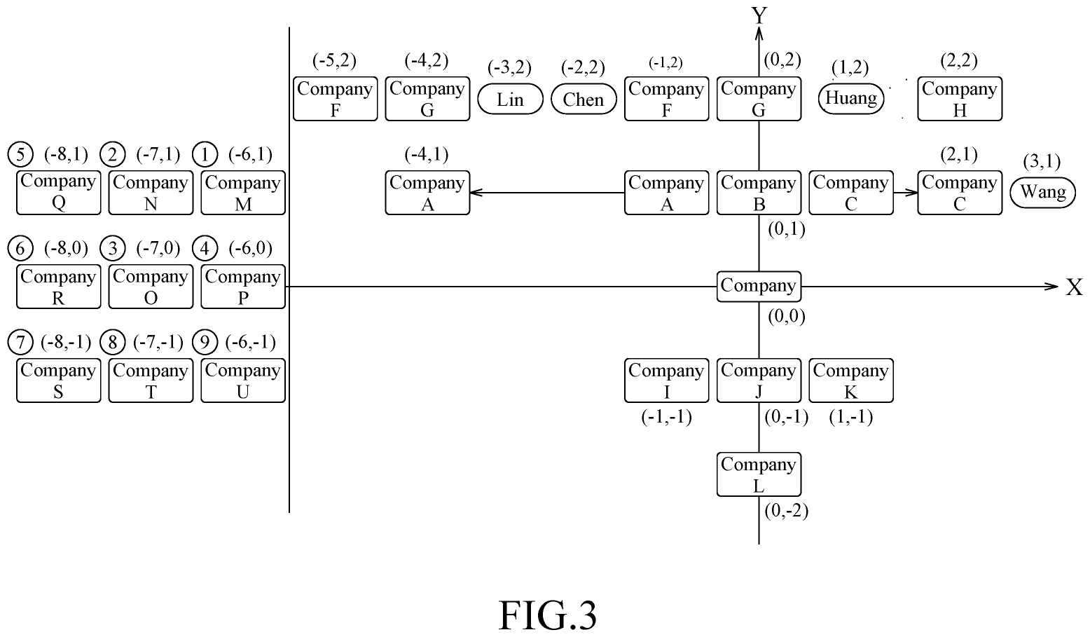

Specifically, FIG. 3 illustrates an intermediate stage of generating an exemplary tree diagram according to one embodiment of the disclosure.

In this embodiment, four direct partial owners “Company A,” “Company B,” and “Company C,” and “Wang” are present, where Company A, Company B and Company C are domestic juridical persons and Wang is a natural person. From the content of the capitalization table, it may be determined that the partial owner Company A owns 20% of the company, the partial owner Company B owns 10% of the company, the partial owner Company C owns 8% of the company, and the partial owner Wang owns 15% of the company.

Four stem node icons are generated for the direct partial owners, respectively. In the example of FIG. 3, each juridical person is represented by a rounded rectangular shape with corner radius of 8 px. The governmental institution and the foreign juridical person may each be represented by a rounded rectangular shape that is similar to the shape used for the juridical person, but in different colors.

It is noted that in some cases, some of the direct partial owners themselves are companies or institutions, and are owned by partial owners who may be natural persons and/or juridical persons. For those partial owners of those direct partial owners (which are referred to as indirect partial owners), a number of stem node icons may also be generated.

In the example of FIG. 3, a plurality of stem node icons are generated, each representing an indirect partial owner to be linked to one of the direct partial owners (e.g., Company D, Company E, Lin, etc.).

In addition to the partial owners, in step S02, a number of stem node icons may also be generated for the subsidiary parties of the company. Similar to the case of the partial owners, the subsidiary parties of the company may be categorized into direct subsidiary parties of the company, whose property is partly owned directly by the company, and indirect subsidiary parties of the company, whose property is partly owned directly by one of the direct subsidiary parties of the company.

In the example of FIG. 3, three direct subsidiary parties “Company I,” “Company J,” and “Company K” are present. From the content of the capitalization table, it may be determined that the direct subsidiary party Company I has 20% of property owned by the company (i.e., 20% of the property of Company I is owned by the company), the direct subsidiary party Company J has 15% of property owned by the company, and the direct subsidiary party Company K has 10% of property owned by the company. Additionally, an indirect subsidiary party Company L is present, and some property thereof is owned by the direct subsidiary party Company J.

Moreover, for each of the affinity parties of the company, a number of stem node icons may also be generated. In the example of FIG. 3, nine stem node icons are generated for nine affinity parties of the company (e.g., Company Q, Company, N, . . . , Company U), respectively.

After the root node icon and the plurality of stem node icons are generated, in step S03, the processor 110 arranges the root node icon and the plurality of stem node icons in the tree diagram.

Specifically, the tree diagram (either a tree diagram in the intermediate stage or a resulting tree diagram) is in the form of a two-dimensional plot that uses Cartesian coordinates. That is to say, the tree diagram has a horizontal axis (i.e., the X axis) and a vertical axis (i.e., the Y axis), and the interactive icons located in the plot may be represented using different sets of (X, Y) coordinates. In this embodiment, the root node icon with the name “Example Enterprise” is generated and is at (0, 0). That is to say, this root node icon is on the origin of the tree diagram, and may be considered as a “root” of the tree diagram.

Then, in arranging the stem node icons, the processor 110 adopts the following rules: for the direct partial owners, the stem node icon of the direct partial owner is assigned an importance value based on the type of entity (natural person or juridical person) and the percentage of ownership of the company, and the importance value of the stem node icon of the direct partial owner is related to the resulting horizontal location of the stem node icon.

Specifically, the importance value related to a partial owner who is a natural person is automatically smaller than that of a partial owner who is not a natural person (e.g., a juridical person). The is to say, the processor 110 is configured to assign a smaller importance value to a stem node icon associated with a partial owner who is a natural person than to a stem node icon associated with a partial owner who is not a natural person. In this case, the sole natural person Wang is automatically assigned the lowest importance value.

Furthermore, for each type of entity of the direct partial owner, the processor 110 is configured to assign to the stem node icon an importance value that is positively related to the percentage of the ownership of the company. Specifically, the greater the percentage of ownership of the company, the larger the importance value of the stem node icon of the direct partial owner. In the case where multiple direct partial owners with the same type of entity have the same percentage of ownership, the importance values may be decided based on alphabetical order, or, in the case of Traditional Chinese names, number of strokes of the first character in the name of each of the direct partial owners. In this example, the direct partial owner with fewer strokes of the first character in the name will be assigned a greater importance value.

In the example of FIG. 3, the percentage of ownership of the direct partial owner Company A (20%) is greater than the percentage of ownership of the direct partial owner Company B (10%), and the percentage of ownership of the direct partial owner Company B is greater than the percentage of ownership of the direct partial owner Company C (8%). Therefore, the importance values of the companies A, B and C may be assigned such that Company A>Company B>Company C. In this way, the stem node icon of the Company A will be disposed with a smallest X value (i.e., farthest to the left), while the stem node icon of Wang will be disposed with a largest X value (i.e., farthest to the right).

Then, in arranging the stem node icons of the direct partial owners, in this embodiment, the stem node icons, each being associated with a respective one of the partial owners with direct ownership of the company Example Enterprise, are arranged on the line Y=1. That is to say, when only taking the Y axis into consideration, the root node icon is disposed at a position different from where the stem node icons are disposed. The line Y=1 may also be referred to as a first layer, and corresponds to the direct partial owners of the company. That is to say, the interactive icons associated with the direct partial owners of the company are arranged in the first layer, each being at a location of (X, 1) which is indicated by an X-value. That is to say, the processor 110 arranges the stem node icons of the direct partial owners above the root node, and the direct partial owners with a highest importance value will be disposed farthest to the left (i.e., a smallest X value). As seen on FIG. 3, the four stem node icons of the four direct partial owners are arranged on the line Y=1.

Additionally, the processor 110 may be configured to align one of the stem node icons in the first layer with the root node on the Y axis to achieve a more organized looking layout. In this embodiment, the processor 110 is configured to select one of the stem node icons in the first layer as a reference icon, and align the reference icon with the root node on the Y axis based on a quantity of the stem node icons of the direct partial owners.

Specifically, in the example of FIG. 3, a total of four stem node icons of the direct partial owners are present in the first layer, and four is an even number. In this case, each of the four stem node icons, from left to right, may be numbered 1, 2, 3 and 4. The greatest number 4 is divided by 2 to result in 2, which is used as the number of the reference icon. As a result, the stem node icon “Company B” is selected as the reference icon and arranged at the location (0, 1). Alternatively, in the case where an odd number of stem node icons of the direct partial owners are present, a median one of the stem node icons may be selected as the reference icon. Generally, when a plurality of stem node icons (a number N) of the direct partial owners are present, the processor 110 may calculate the number ceil(N/2), which is defined as a smallest integer that is no less than N/2 (i.e., taking the ceiling of N/2), and select one of the stem node icons numbered ceil(N/2) as the reference icon. It is noted that in other embodiments, various ways of selecting the reference icon may be employed.

In arranging the stem node icons of the indirect partial owners, each of the indirect partial owners may be first sorted into one of a number of groups based on an association with one of the direct partial owners, and assigned an importance value with respect to a corresponding one of the groups using the above rules before being arranged. In the example of FIG. 3, the indirect partial owners Company D, Company E, Lin and Chen are associated with the direct partial owner Company A, the indirect partial owners Company F, Company G and Huang are associated with the direct partial owner Company B, and the indirect partial owner Company H is associated with the direct partial owner Company C. As such, the stem node icons of the indirect partial owners are sorted into three groups each being associated with one of the direct partial owners.

Then, for each of the three groups, an importance value is assigned to each of the stem node icons included in the group. In the example of FIG. 3, the four indirect partial owners in the group associated with the direct partial owner Company A are sorted based on their importance values from highest to lowest in the following order: Company D (20%), Company E (5%), Lin (30%) and Chen (10%). The three indirect partial owners in the group associated with the direct partial owner Company B are sorted based on their importance values from highest to lowest in the following order: Company F (40%), Company G (5%) and Huang (15%).

Then, the stem node icons of the indirect partial owners are arranged on the line Y=2. That is to say, the stem node icons of the indirect partial owners are arranged above the stem node icons of the direct partial owners and the root node (i.e., in a second layer that is different from the first layer). In this embodiment, the relative horizontal locations of the stem node icons in each of the groups in the second layer are arranged based on the relative horizontal location of the stem node icon of the corresponding direct partial owner in the first layer. In the cases where more layers of stem node icons are present (e.g., a number M of layers are present), the relative horizontal locations of the stem node icons of each of the groups in the N^{th} layer are arranged based on the relative horizontal location of the stem node icon of the corresponding partial owner in the (N−1)^{th} layer.

Specifically, in arranging the stem node icons of the indirect partial owners, one of the stem node icons is first selected as a reference icon to be aligned with the root node on the Y axis. Since the stem node icon of the direct partial owner Company B is disposed at (0, 1), the group associated with the direct partial owner Company B is first selected. Then, since this group includes three stem node icons, then using the above rules, since the number ceil(3/2])=2, the second stem node icon (Company G) is selected as the reference icon to be aligned with the root node on the Y axis. As a result, the stem node icon associated with Company G is disposed at (0, 2). It is noted that when additional layers of stem node icons are present, a reference icon will be similarly selected for each of the layers.

Subsequently, other stem node icons of the indirect partial owners may be arranged at different horizontal positions on the line Y=2 (i.e., along the line Y=2, or in the second layer), using the reference icon as a reference point. Specifically, within the same group, the stem node icon associated with Company F is disposed at (−1, 2), and the stem node icon associated with Huang is disposed at (1, 2). For the group associated with company C, the stem node icon associated with Company H is disposed at (2, 2). For the group associated with Company A, the stem node icon associated with Chen is disposed at (−2, 2), the stem node icon associated with Lin is disposed at (−3, 2), the stem node icon associated with Company E is disposed at (−4, 2), and the stem node icon associated with Company D is disposed at (−5, 2).

Generally, in the cases where there are a plurality of layers of stem node icons associated with the related-parties of the company, the processor 110 first selects, from the first layer of stem node icons associated with the related-parties, a first reference icon to be aligned with the root node icon based on a number N of stem node icons that are present in the first layer. In some embodiments, a ceil(N/2)^{th} stem node icon in the first layer is selected as the first reference icon. Then, for a plurality of stem node icons associated with the related-parties in a second layer (or subsequent layers), these stem node icons are sorted into a plurality of groups each associated with one of the stem node icons in the first layer (or a previous layer). Then, the processor 110 selects a second (or subsequent) reference icon to be aligned with the first reference icon from among the stem node icons of one of the groups that is associated with the first reference icon. Such a process may continue with respect to a K^{th} layer, in which a K^{th} reference icon is selected to be aligned with a (K−1)^{th} reference icon (or the root node icon) based on a number M of stem node icons that are included in a group of stem node icons which are present in the K^{th} layer and associated with the (K−1)^{th} reference icon. In some embodiments, a ceil(M/2)^{th} stem node icon in the K^{th} layer is selected as the K^{th} reference icon, and ceil(M/2) is a smallest integer that is no less than M/2. It is noted that in some embodiments, for each of the layers, the horizontal locations of the stem node icons are arranged based on the importance values and the associated reference icon selected.

Afterward, for the stem node icons associated with the direct partial owners, since each of the direct partial owners may have a number of associated indirect partial owners, the horizontal locations of the stem node icons associated with the direct partial owners may be shifted horizontally to be more aligned with the associated indirect partial owners. In the example of FIG. 3, originally, the stem node icon associated with Company A is disposed at (−1, 1), and the stem node icon associated with Company C is disposed at (1, 1) without the indirect partial owners. After the stem node icons of the indirect partial owners in the second layer (i.e., on the line Y=2) are arranged, the locations of the stem node icons of the indirect partial owners and the stem node icon of the associated direct partial owners may become far apart. As such, the horizontal location of the stem node icon associated with each direct partial owner may be adjusted to be aligned with the stem node icons associated with the indirect partial owners based on the above rules. For example, the stem node icon associated with Company A may be moved to (−4, 1) so as to align with the second stem node icon of the group associated with Company A, and the stem node icon associated with Company C may be moved to (2, 1) so as to align with the stem node icon of the group associated with Company C.

It is noted that in this embodiment, the interactive icons in a same layer are aligned along a first direction, (i.e., the horizontal direction in the example of FIG. 3), and the different layers are spaced apart from one another along a second direction perpendicular to the first direction (i.e., the vertical direction in the example of FIG. 3).

In the cases where one of the indirect partial owners also has one or more direct partial owners, further stem node icon(s) may be generated and arranged on the line Y=3 in a manner that is similar to that as described above. In such cases, the stem node icons disposed in the second layer (on the line Y=2) and/or in the first layer (on the line Y=1) may be shifted horizontally to align with the newly generated stem node icon(s) when it is determined by the processor 110 to be necessary. The determination may be done by determining, for each group of stem node icons disposed in a Y^{th} layer, an expected reference point for the corresponding stem node icon in a (Y−1)^{th} layer (e.g., when three stem node icons are present in a group in the Y^{th} layer, the corresponding stem node icon may be expected to be disposed directly below the second stem node icon in the (Y−1)^{th} layer). When it is determined that the corresponding stem node icon in the (Y−1)^{th} layer is not at the expected reference point, the corresponding stem node icon in the (Y−1)^{th} layer may be then shifted horizontally to the expected reference point.

In arranging the stem node icons associated with the subsidiary parties of the company, the processor 110 arranges the stem node icons associated with the subsidiary parties of the company at an opposite side to the stem node icons associated with the partial owners in the tree diagram with respect to the root node icon. For example, in the example of FIG. 3, all the stem node icons associated with the partial owners are arranged above the root node icon (i.e., above the X axis), and the stem node icons associated with the subsidiary parties are arranged below the root node icon (i.e., below the X axis).

Generally, the arrangement of the stem node icons associated with the subsidiary parties of the company is performed in a manner similar to arranging the stem node icons associated with the partial owners of the company. In the example of FIG. 3, the three direct subsidiary parties of the company are sorted based on their importance values from highest to lowest in the following order: Company I, Company J, Company K. It is noted that in some embodiments, importance values of the stem node icons of the direct subsidiary parties of the company are assigned to be positively related to the percentage of the ownership by the company, but is not limited to such.

As a result, the stem node icon associated with Company I is disposed at (−1, −1), the stem node icon associated with Company J is disposed at (0, −1), the stem node icon associated with Company K is disposed at (1, −1). It is noted that the second stem node icon (out of three) is selected to be aligned with the root node on the Y axis. The stem node icons associated with the direct subsidiary parties of the company are also said to be arranged in a first layer (i.e., on the line Y=−1) along the first direction.

Then, the stem node icon associated with the indirect subsidiary party Company L, whose property is directly owned by the direct subsidiary party Company J, is disposed at (0, −2). The stem node icons associated with the indirect subsidiary parties of the company are also said to be arranged in a second layer (i.e., on the line Y=−2), different from the first layer, along the first direction.

It is noted that in the cases where a number M of layers of stem node icons associated with the subsidiary parties of the company are present, relative horizontal locations of the stem node icons in each of the groups in the N^{th} layer are also arranged based on the relative horizontal location of the stem node icon of the corresponding relative party in the (N−1)^{th} layer.

After the stem node icons associated with the partial owners and the stem node icons associated with the subsidiary parties are arranged, the stem node icons associated with the affinity parties of the company may then be arranged. In embodiments, the stem node icons associated with the partial owners and the stem node icons associated with the subsidiary parties are arranged on two opposite sides of the tree diagram (e.g., top and bottom sides as seen in FIG. 3), and the stem node icons associated with the affinity parties are arranged on a third side that is different from the two opposite sides (e.g., a left side as seen in FIG. 3)

Specifically, for each of the affinity parties, an importance value is assigned thereto by the processor 110 based on a sum of a number of relationships between the affinity party and the partial owners, and a number of relationships between the affinity party and the subsidiary parties. In some embodiments, a “relationship” may be an investment relationship where one of the entities owns property of the other. The larger the sum for an affinity party, the larger the importance value assigned thereto.

Then, the processor 110 arranges the stem node icons associated with the affinity parties in the following manner. Firstly, the stem node icons associated with the affinity parties are arranged, based on the importance values, in an attempt to construct an n*n square matrix. Specifically, when two to four stem node icons are present, the stem node icons are arranged in the form of a 2*2 matrix based on the importance values, in an order labeled as 1-4 on FIG. 3 (i.e., the stem node icon with a highest importance value is placed at a location labeled 1, the stem node icon with a second highest importance value is placed at a location labeled 2, and so on). When five to nine stem node icons are present, the stem node icons are arranged in the form of a 3*3 matrix based on the importance values, in the order labeled as 1-9 on FIG. 3 (i.e., the stem node icon with a fifth highest importance value is placed at a location labeled 5, the stem node icon with a sixth highest importance value is placed at a location labeled 6, and so on). It is noted that in the example of FIG. 3, when three to six stem node icons are present, the arrangement of the stem node icons results in a two-level stack, and when seven to nine stem node icons are present, the arrangement of the stem node icons results in a three-level stack.

Then, in this embodiment, based on a number M of level of stack(s), the processor 110 selects an ceil(M/2)^{th} level as a reference level to be aligned with the X axis (therefore, aligned with the root node icon). That is to say, in the example of FIG. 3, the second level is aligned with the X axis.

Afterward, It is noted that in this embodiment, in order to avoid the potential issue of having a stem node icon associated with an affinity party disposed at a same location as a stem node icon associated with a partial owner or a stem node icon associated with a subsidiary party, a starting location of the stem node icon associated with the affinity party is selected to be further to the left than the stem node icon that is associated with a partial owner or a subsidiary party and that is farthest to the left. In the example of FIG. 3, since the stem node icon associated with Company D is disposed at (−5, 2), the stem node icon associated with the affinity party Company M is first disposed at (−6, 1). Then, the stem node icon associated with the affinity party Company N is disposed at (−7, 1), followed by the stem node icon associated with the affinity party Company O being disposed at (−7, 0) and the stem node icon associated with the affinity party Company P being disposed at (−6, 0). Other stem node icons associated with the affinity parties are similarly disposed in order, so as to generate the tree diagram as shown in FIG. 3.

In this embodiment, in order to simplify presentation of the tree diagram, when a specific entity (e.g., the company, one of the partial owners, one of the subsidiary parties, or one of the affinity parties) appears more than once in the tree diagram, only one interactive icon that represents the entity and that is the most important is kept, and other interactive icons that are deemed as duplicates will be removed. That is to say, in the case where multiple interactive icons associated with the same entity are generated, the processor 110 is configured to select one of the interactive icons as a representative interactive icon for the entity that appears more than once in the tree diagram, keep the representative interactive icon in the tree diagram, and remove other interactive icons from the tree diagram.

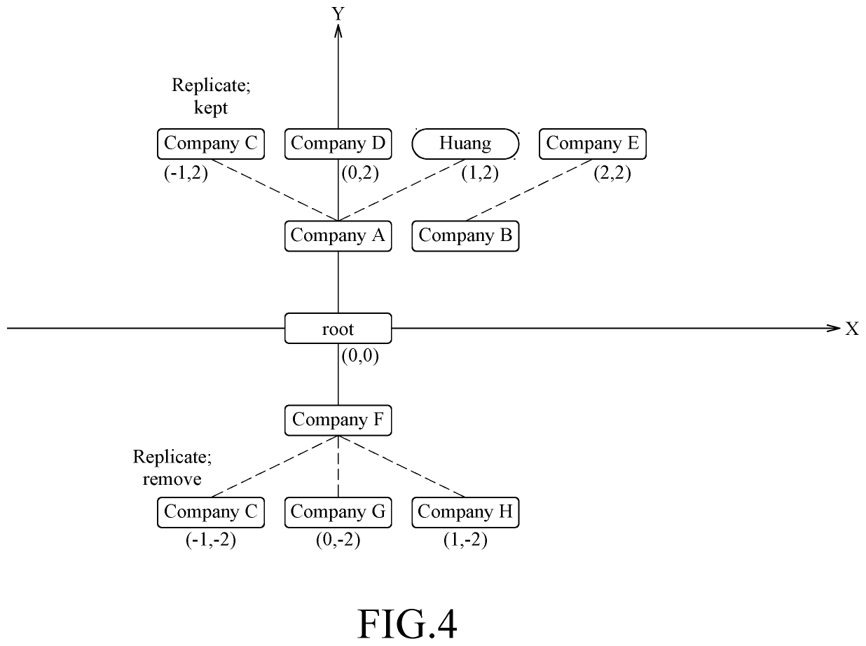

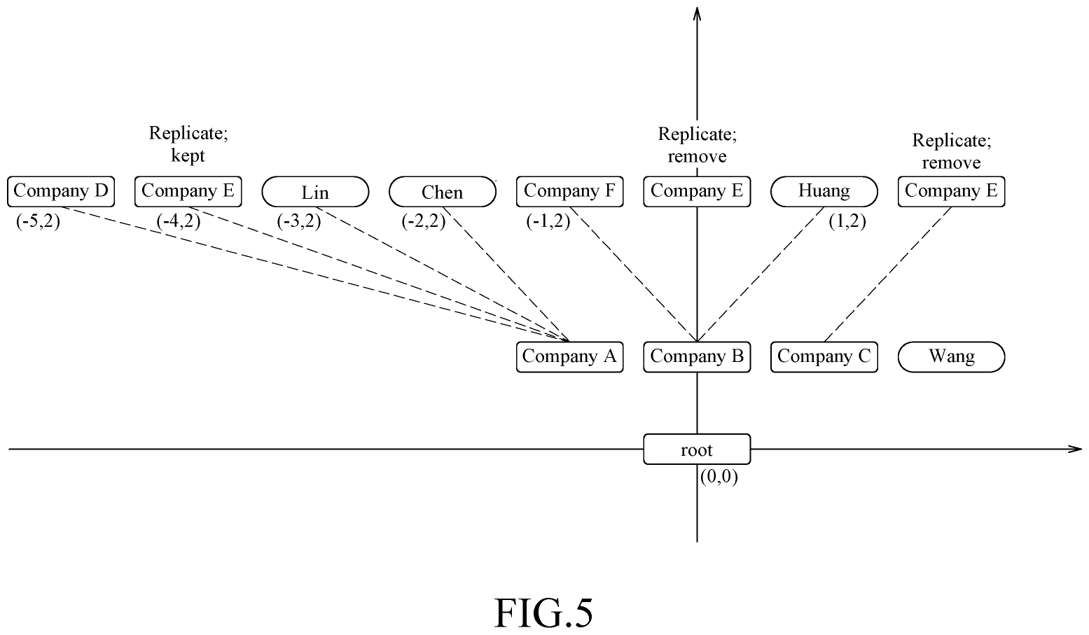

In an example of FIG. 4 which is different from the example of FIG. 3, the stem node icon representing the entity “Company C” appears more than once, i.e., at coordinates (−1, 2) as a partial owner, and at coordinates (−1, −2) as a subsidiary party. In this embodiment, a stem node icon representing a partial owner is deemed more important than, and hence selected as the representative interactive icon over, a stem node icon representing a subsidiary party. In this case, the stem node icon at (−1, 2) is kept, and the stem node icon at (−1, −2) is removed. In the cases where multiple interactive icons representing the same entity as partial owners or as subsidiary parties appear in different layers (e.g., the first and the second layers), the interactive icon appearing in the layer that is closest to the root node icon is selected as the representative interactive icon. In the case where multiple interactive icons representing the same entity appear in the same layer, the interactive icon with the smallest X value (farthest to the left) is selected as the representative interactive icon. In an example of FIG. 5 which is different from the examples of FIGS. 3 and 4, the stem node icon representing the entity “Company E” appears more than once, i.e., at coordinates (−4, 2), (0, 2), and (2, 2). As such, the two stem node icons at coordinates (0, 2), and (2, 2) are removed. It is noted that after the duplicate interactive icon(s) are removed, the horizontal locations of the remaining interactive icons may be further adjusted based on the above rules.

It is noted that in the case where the company represented by the root node icon is also a direct partial owner of other partial owners (e.g., a stem node icon associated with the company is generated), the root node icon is automatically selected as the representative interactive icon. That is to say, all of the stem node icon(s) indicating the company are removed, leaving only the root node icon in the tree diagram.

After the arrangement of the root node icon and the stem node icons is completed, in step S04, the processor 110 plots a plurality of vertical auxiliary lines and a plurality of horizontal auxiliary lines for the interactive icons on the tree diagram.

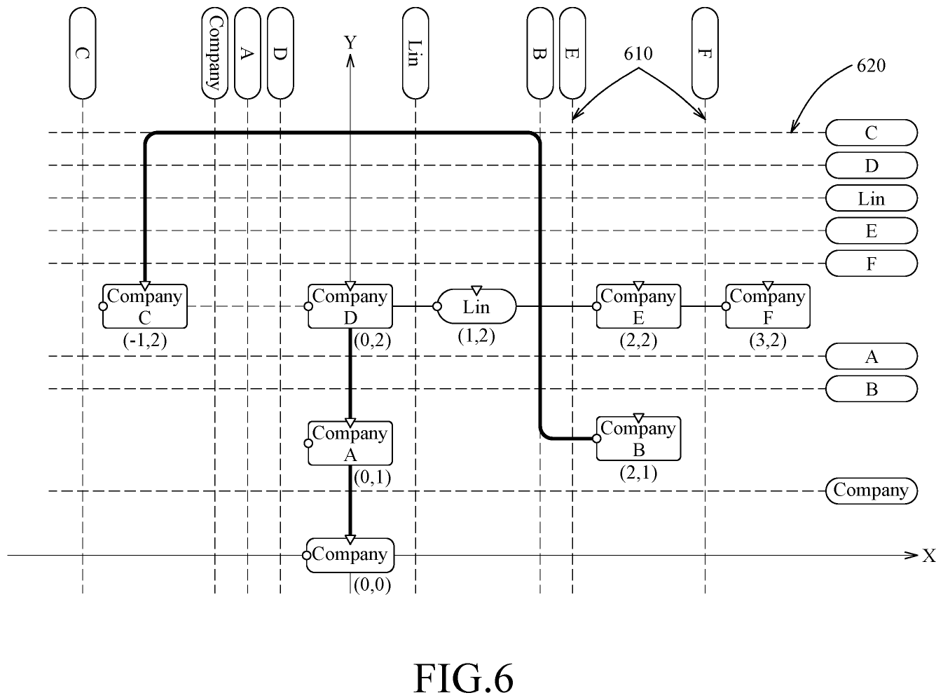

In an example of FIG. 6 which is different from the examples of FIGS. 3 to 5, for each of the interactive icons, a vertical auxiliary line 610 is drawn to the left of the interactive icon, between the interactive icon and a nearby interactive icon to the left. For example, the stem node icon “Company F” is disposed at coordinates (3, 2), and a nearby stem node icon “Company E” to the left is disposed at coordinates (2, 2). As a result, a vertical auxiliary line 610 associated with the stem node icon “Company F” is drawn between the lines X=3 and X=2 (indicated by the symbol F). Then, for the stem node icons “Company E” and “Company B,” two vertical auxiliary lines 610 are drawn between the lines X=2 and X=1, with the vertical auxiliary line 610 associated with stem node icon “Company E” being closer to the stem node icons “Company E” and “Company B.”

Then, for each of the interactive icons, a horizontal auxiliary line 620 is drawn on above the interactive icon, between the interactive icon and a nearby interactive icon on top. For example, the root node icon is disposed at coordinates (0, 0), and a nearby stem node icon “Company A” on top is disposed at coordinates (0, 1). As a result, a horizontal auxiliary line 620 associated with the root node icon is drawn between the lines Y=0 and Y=1. Then, for the stem node icons “Company A” and “Company B,” two horizontal auxiliary lines 620 are drawn between the lines Y=1 and Y=2, with the horizontal auxiliary line 620 associated with stem node icon “Company B” being closer to the stem node icons. Other vertical auxiliary lines 610 and horizontal auxiliary lines 620 are drawn in a similar manner.

In step S05, the processor 110 plots a plurality of investment routes each connecting two interactive icons arranged in the tree diagram.

Specifically, each of the direct or indirect partial owners owns the company. The ownership may be a direct ownership (in which the partial owner owns a certain percentage of the company), an indirect ownership (in which the partial owner owns a certain percentage of another partial owner), or both.

For direct ownerships, the processor 110 plots an investment route from one of the stem node icons that is associated with a corresponding one of the related-parties (e.g., a partial owner) to connect to another interactive icon that is associated with another entity partially owned by the corresponding one of the related-parties (e.g., the company). In the example of FIG. 6, one investment route starts from the stem node icon “Company D” and ends at the stem node icon “Company A”, and another investment route starts from the stem node icon “Company A” and ends at the root node icon. The investment routes may each include an arrow pointing toward the root node icon representing the entity that is receiving investment from a partial owner. In addition, the processor 110 may plot an investment route from the root node icon to a stem node icon of a direct subsidiary party, and from a stem node icons of a direct subsidiary party to an indirect subsidiary party.

In addition to the investment routes related to the root node icon, in step S05, the processor 110 may plot other investment routes involving any two of the interactive icons in the tree diagram.

In the example of FIG. 6, it is noted that Company B (stem node icon at coordinates (2, 1)) is a partial owner of Company C (stem node icon at coordinates (−1, 2)). In this embodiment, an investment route is to be plotted from the stem node icon representing Company B to the stem node icon representing Company C. Specifically, the investment route from the stem node icon representing the partial owner Company B may start from a left side of the stem node icon at (2, 1), extend toward the left to reach one of the vertical auxiliary lines 610 that is associated with the partial owner Company B, extend upwardly to reach one of the horizontal auxiliary lines 620 that is associated with the partial owner Company C, extend toward the left along this horizontal auxiliary line 620, and extend downwardly to connect to a top side of the stem node icon representing Company C at (−1, 2). The investment route may include an arrow pointing toward the stem node icon representing Company C, which indicates that Company C is receiving investment from Company B.

Generally, an investment route between one and another of the stem node icons is plotted to start at one side of the one of the stem node icons, extend until in contact with one of the vertical auxiliary line and the horizontal auxiliary line associated with the one of the stem node icons, extend along the one of the vertical auxiliary line and the horizontal auxiliary line associated with the one of the stem node icons until in contact with one of the vertical auxiliary line and the horizontal auxiliary line associated with the another one of the stem node icons, extend along the one of the vertical auxiliary line and the horizontal auxiliary line associated with the another one of the stem node icons until in direct proximity to the another one of the stem node icons, and extend to contact the another one of the stem node icons.

It is noted that in the case where the partial ownership exists among other entities (i.e., a partial owner, a subsidiary party or an affinity party) in the tree diagram, additional investment routes may be plotted in a similar manner.

It is noted in this embodiment, the corners of the investment routes are designed to be rounded, but other implementations may also be employed.

In step S06, the processor 110 generates and stores the tree diagram, and the process is terminated. The resulting tree diagram may then be displayed on the display 116 of the electronic device 100, or be transmitted (e.g., via the Internet) in the form of a data file for display by another electronic device.

In use, when a user operates the electronic device 100 to generate the tree diagram, or to access a tree diagram that is generated in advance, the processor 110 may control the display 116 to display the tree diagram. Each of the interactive icons included in the tree diagram may be interactive. For example, when the user operates a mouse of the interface 118 to input a first command directed to one of the interactive icons on the tree diagram (e.g., left clicking on one of the stem node icons), the processor 110, in response to receipt of the first command, may in turn make the display 116 display the information associated with the related-party that corresponds to the one of the interactive icons. The information may include a name of the related-party, the percentage of ownership associated with the related-party, whether the related-party is a company listed in a stock exchange (e.g., the Taiwan Stock Exchange), whether the related-party is a company listed in an over-the-counter (OTC) market, a list of names of a board of directors of the related-party, etc.

In some embodiments, the investment routes may be initially not shown in order to simplify the look of the tree diagram. Instead, when the user inputs a command directed to one of the interactive icons on the tree diagram (e.g., right clicking on the one of the interactive icons, followed by a selection of a button of “display investment routes” (not shown)), the processor 110 may display one or more investment routes that involve the one of the interactive icons.

To sum up, the embodiments of the disclosure provide a method for generating the tree diagram of a shareholding structure from the capitalization table of the company. Using this method, the partial owners, the subsidiary parties and the affinity parties of the company are sorted and clearly arranged on different sides in the tree diagram, with the importance of each of the partial owners and subsidiary parties being presented by the horizontal location of corresponding stem node icon. Also, the investment routes are drawn to clearly illustrate the relationships of various entities in the tree diagram. In addition, in the case where there are too many investment routes for specific interactive icons, the investment routes may be initially hidden and shown only when instructed.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for generating a tree diagram of a shareholding structure from a capitalization table of a company, content of the capitalization table including a name of the company, and a plurality of related-party datasets that respectively correspond to a plurality of related-parties, each of the related-party datasets including a name of the respective related-party, a type of entity of the respective related-party, and a percentage of ownership related to the respective related-party, each of the related-parties being one of a partial owner of the company who owns a percentage of the property of the company and a subsidiary party a percentage of whose property is owned by the company, the method being implemented using a processor of an electronic device and comprising:
in response to receipt of user input instructions, loading the capitalization table of the company;
generating a plurality of interactive icons that are associated with the company and the related-parties for the tree diagram, wherein the interactive icons include a root node icon that is associated with the company, and a plurality of stem node icons that are each associated with a respective one of the related-party datasets;
arranging the plurality of interactive icons including the root node icon and the plurality of stem node icons in the tree diagram, the tree diagram being in the form of a two-dimensional plot, wherein arranging the plurality of interactive icons includes:
arranging the root node icon at an origin of the tree diagram,
arranging those of the stem node icons that are associated with partial owners on one side of the tree diagram, and
arranging those of the stem node icons that are associated with subsidiary parties on an opposite side of the tree diagram; and
plotting a plurality of investment routes each connecting two interactive icons arranged in the tree diagram.

2. The method as claimed in claim 1, the partial owner being one of a direct partial owner that is directly associated with the company and an indirect partial owner that is associated with the direct partial owner, the subsidiary party being one of a direct subsidiary party that is directly associated with the company and an indirect subsidiary party that is associated with the direct subsidiary party, wherein arranging those of the stem node icons that are associated with the partial owners includes:
for each of the stem node icons that is associated with a direct partial owner, assigning an importance value to the stem node icon and arranging the stem node icon in a first layer based on the importance value;
for each of the stem node icons that is associated with an indirect partial owner, assigning an importance value to the stem node icon and arranging the stem node icon in a layer different from the first layer based on the importance value;
wherein arranging those of the stem node icons that are associated with the subsidiary parties includes
for each of the stem node icons that is associated with a direct subsidiary party, assigning an importance value to the stem node icon and arranging the stem node icon in another first layer based on the importance value;
for each of the stem node icons that is associated with an indirect subsidiary party, assigning an importance value to the stem node icon and arranging the stem node icon in a layer different from the first layer and the another first layer based on the importance value; and
wherein the interactive icons in a same layer are aligned along a first direction, and the different layers are spaced apart from one another along a second direction perpendicular to the first direction.

3. The method as claimed in claim 2, wherein assigning an importance value to each of the stem node icons includes sorting each of the indirect partial owners into one of a number of groups based on an association with one of the direct partial owners, and assigning each of the indirect partial owners with an importance value with respect to a corresponding one of the groups.

4. The method as claimed in claim 3, the type of entity of the partial owner being one of a natural person, a domestic juridical person, a governmental institution and a foreign juridical person,
assigning an importance value to each of the stem node icons further includes:
assigning an importance value to the stem node icon associated with a partial owner that is a natural person to be lower than that assigned to the stem node icon associated with a partial owner that is not a natural person;
for each of the partial owners that is a natural person, assigning an importance value that is positively related to the percentage of the ownership of the company to the corresponding stem node icon;
for each of the partial owners that is not a natural person, assigning an importance value that is positively related to the percentage of the ownership of the company to the corresponding stem node icon; and
for each of the subsidiary parties, assigning an importance value that is positively related to the percentage of the ownership by the company to the corresponding stem node icon.

5. The method as claimed in claim 4, there being a plurality of layers of stem node icons associated with the partial owners and a plurality of layers of stem node icons associated with the subsidiary parties, wherein:
relative horizontal locations of the stem node icons in each of the groups associated with the partial owners in the N^{th} layer are arranged based on the relative horizontal location of the stem node icon of the corresponding partial owners in the (N−1)^{th} layer;
relative horizontal locations of the stem node icons in each of the groups associated with the subsidiary parties on the N^{th} layer are arranged based on the relative horizontal location of the stem node icon of the corresponding subsidiary party in the (N−1)^{th} layer.

6. The method as claimed in claim 5, further comprising:
selecting, from the first layer of stem node icons associated with the related-parties, a first reference icon to be aligned with the root node icon based on a number N of stem node icons that are present in the first layer, wherein a ceil(N/2)^{th} stem node icon in the first layer is selected as the first reference icon, ceil(N/2) being a smallest integer that is no less than N/2;
selecting, from a K^{th} layer of stem node icons associated with the related-parties, a K^{th} reference icon to be aligned with a (K−1)^{th} reference icon, which is aligned with the root node icon, based on a number M of stem node icons that are included in a group of stem node icons which are present in the K^{th} layer and associated with the (K−1)^{th} reference icon, wherein a ceil(M/2)^{th} stem node icon in the group in the K^{th} layer is selected as the (K)^{th} reference icon, ceil(M/2) being a smallest integer that is no less than M/2; and
for each of the layers, arranging the horizontal locations of the stem node icons in the layer based on the importance values of the stem node icons in the layer and the reference icon for the layer.

7. The method as claimed in claim 6, further comprising, after arranging the horizontal locations of the stem node icons for each of the layers:
determining, for each group of stem node icons disposed in a Y^{th} layer, an expected reference point for the corresponding stem node icon in a (Y−1)^{th} layer; and
when it is determined that the corresponding stem node icon is not at the expected reference point, shifting the corresponding stem node icon horizontally to the expected reference point.

8. The method as claimed in claim 2, further comprising:
in a case where multiple interactive icons associated with a same entity are generated, selecting one of the interactive icons as a representative interactive icon for the entity, keeping the representative interactive icon in the tree diagram, and removing other interactive icons from the tree diagram;
wherein
a stem node icon representing a partial owner is selected as the representative interactive icon over a stem node icon representing a subsidiary party, and
in the case where multiple interactive icons representing the same entity as partial owners or as subsidiary parties appear in different layers, the interactive icon appearing in the layer that is closest to the root node icon is selected as the representative interactive icon.

9. The method as claimed in claim 1, each of the related-parties being one of a partial owner, a subsidiary party and an affinity party which owns a percentage of the property of a subsidiary party of the company and has a percentage of the property that is owned by a partial owner of the company, wherein:
the generating a plurality of interactive icons includes generating a plurality of stem node icons that are associated with the affinity parties of the company, respectively; and
the arranging the plurality of interactive icons further includes arranging those of the stem node icons that are associated with the affinity parties on another side of the tree diagram that is different from the one side and the opposite side of the tree diagram.

10. The method as claimed in claim 9, wherein the arranging those of the stem node icons that are associated with the affinity parties includes:
assigning an importance value to each of those of the stem node icons; and
arranging those of the stem node icons based on the importance values in order to construct an n*n square matrix.

11. The method as claimed in claim 10, wherein the assigning of the importance value to each of those of the stem node icons includes assigning the importance value based on a sum of a number of relationships between the associated affinity party and the partial owners, and a number of relationships between the associated affinity party and the subsidiary parties.

12. The method as claimed in claim 10, the stem node icons associated with the affinity parties being arranged in an M-level stack, wherein the arranging those of the stem node icons that are associated with the affinity parties further includes selecting a ceil(M/2)^{th} level as a reference level to be aligned with the root node icon, ceil(M/2) being a smallest integer that is no less than M/2.

13. The method as claimed in claim 9, further comprising, after the arranging the plurality of interactive icons, for each of the interactive icons:
plotting a vertical auxiliary line to the left of the interactive icon, between the interactive icon and a nearby interactive icon to the left; and
plotting a horizontal auxiliary line on above the interactive icon, between the interactive icon and a nearby interactive icon on top.

14. The method as claimed in claim 13, wherein the plotting a plurality of investment routes includes:
plotting an investment route from one of the stem node icons that is associated with one of the related-parties to connect to another interactive icon that is associated with another entity partially owned by the one of the related-parties;
wherein the investment route between one of the stem node icons and another of the stem node icons is plotted to
start at one side of the one of the stem node icons,
extend until in contact with one of the vertical auxiliary line and the horizontal auxiliary line associated with the one of the stem node icons,
extend along the one of the vertical auxiliary line and the horizontal auxiliary line associated with the one of the stem node icons until in contact with one of the vertical auxiliary line and the horizontal auxiliary line associated with the another one of the stem node icons,
extend along the one of the vertical auxiliary line and the horizontal auxiliary line associated with the another one of the stem node icons until in direct proximity to the other one of the stem node icons, and
extend to contact the another one of the stem node icons.

15. The method as claimed in claim 1, the electronic device including an interface and a display, the method further comprising:
controlling the display to display the tree diagram; and
in response to receipt of a first command directed to one of the interactive icons on the tree diagram via the interface, make the display display information associated with one of the related-parties that corresponds to the one of the interactive icons.

16. The method as claimed in claim 15, wherein:
the tree diagram is initially displayed without showing the investment routes;
the method further comprising: in response to receipt of a second command directed to one of the interactive icons on the tree diagram via the interface, display one or more investment routes that involve the one of the interactive icons.
